(19) United States
(12) Patent Application Publication
(10) Pub. No.: US 2017/0203519 A1
(43) Pub. Date: Jul. 20, 2017

(54) FABRICATION OF PAPER BASED OBJECTS HAVING UNIQUE EMBEDDED CONSUMER CONTENT

(71) Applicant: ASi3D, LLC., Fairfield, CT (US)

(72) Inventors: Arnold Lewis, Fairfield, CT (US); Seth Lewis, Fairfield, CT (US)

(21) Appl. No.: 15/404,764

(22) Filed: Jan. 12, 2017

Related U.S. Application Data
(60) Provisional application No. 62/279,064, filed on Jan. 15, 2016.

(51) Int. Cl. B29C 67/00; B33Y 10/00; B33Y 30/00; B33Y 50/02; B32B 41/00; B33Y 70/00; B32B 29/00; B44C 5/04; B32B 37/18; B32B 38/00; B33Y 80/00; B33Y 40/00

(52) U.S. Cl. CPC B29C 67/0088; B33Y 80/00; B33Y 10/00; B33Y 30/00; B33Y 50/02; B33Y 40/00; B33Y 70/00; B32B 29/005; B44C 5/04; B32B 37/18; B32B 38/0004; B32B 41/00; B32B 38/145; B32B 2451/00; B32B 2250/26; B32B 2255/12; B32B 2317/12; G05B 2219/35134; G05B 2219/49007

(57) ABSTRACT

A process for making an object having unique embedded user content from paper feedstock, includes receiving content from a user, processing the content to produce a paper based three dimensional (3D) printer computer aided design model of an object incorporating the content, and using a paper based 3D printer to produce a finished object from paper feedstock using the computer aided design model, wherein the content is imprinted in the finished object.

The disclosed embodiments generally relate to structures and techniques for producing unique paper based objects having embedded consumer content.

### BACKGROUND

Present processes for placing unique end user provided content in or onto various objects are generally limited to unique manual methods to imbed content by an individual artisan, printing content onto flat or convex or concave surfaces of another tangible object, or printing on or into coarse extruded feedstock that is of a preset color or onto layers of powders and/or resin.

### SUMMARY

In at least one aspect, the disclosed embodiments are directed to a process for making an object from paper feedstock, where the user provides content, for example, an image, the content is processed into a separately created template object to yield a Computer Aided Design (CAD) model of the object for a paper based three dimensional (3D) printer, and the paper based 3D printer produces a finished object from paper feedstock with the content embedded in the finished object.

In another aspect, the disclosed embodiments are directed to an object made from paper feedstock using a customer supplied image.

In a further aspect, the disclosed embodiments are directed to providing a unique object with an embedded image, made from paper feedstock using 3D printing.

In a still further aspect, the disclosed embodiments are directed to using a 3D printer to imbed any unique end user provided content into a colorful object that may be designed and created using one or more computer software program or programs.

The disclosed embodiments advantageously allow a user to create a unique, custom, object incorporating user supplied personal content.

The user may select one or more colors, color schemes, textures, coatings, surface appearances, or other characteristics of the object.

The user may select the one or more characteristics from a predetermined set or may specify one or more custom characteristics.

The one or more colors, color schemes, textures, coatings, surface appearances, or other characteristics may be incorporated into the object on a layer by layer basis because the paper based 3D printer produces the object from multiple paper layers.

An outer coating may be applied to a finished object. The outer coating may be transparent, translucent, or opaque.

The image may be an image of a photograph, document, drawing, letter, number, symbol, two dimensional shape, or any other image.

The finished object may be an item of wearable art, a charm, bangle, bauble, keychain, pendant, or other jewelry item, a plaque, trophy, doll, figure, or any suitable 3D object.

The finished object may have the texture, color or shape of an object made of wood, metal or stone.

The user may designate or describe the object, or may pick the designated object from a menu of objects.

In one or more exemplary embodiments, the presently disclosed techniques use a 3D printing technology that prints color on paper and laminates the paper together. A further process then finishes the laminated object by providing a durable coating.

The disclosed embodiments are also directed to a process for making an object having unique embedded user content from paper feedstock. The process includes receiving content from a user, processing the content to produce a paper based three dimensional (3D) printer computer aided design model of an object incorporating the content, and using a paper based 3D printer to produce a finished object from paper feedstock using the computer aided design model, wherein the content is imprinted in the finished object.

The content may include an image of one or more of artwork, a design, a document, a drawing, an image, a letter, a logo, a number, a photograph, a symbol, and a two dimensional shape.

Processing the content may further include selecting one or more colors, color schemes, textures, coatings, surface appearances, or other characteristics of the object.

Processing the content may also include incorporating the selected one or more colors, color schemes, textures, coatings, surface appearances, or other characteristics into the paper based 3D printer computer aided design model of the object.

Processing the content may still further include using a selected template of the object to produce the paper based 3D printer computer aided design model of the object.

The finished object may be a jewelry piece and the process may further include adding one or findings to the jewelry piece.

The process may further include applying a coating to the finished object.

The process may also include using the paper based 3D printer to produce a plurality of finished objects from paper feedstock using the computer aided design model and assembling the plurality of finished objects together as a final object.

The final object may be a plaque.

The disclosed embodiments are directed to an apparatus for making an object having unique embedded user content from paper feedstock. The apparatus may include a computing apparatus having a processor and a memory with computer readable program code. The processor under control of the computer readable program code may be configured to receive content from a user and process the content to produce a paper based three dimensional (3D) printer computer aided design model of an object incorporating the content;

The apparatus may further include a paper based 3D printer configured to produce a finished object from paper feedstock using the computer aided design model, wherein the content is imprinted in the finished object.

The content may include an image of one or more of artwork, a design, a document, a drawing, an image, a letter, a logo, a number, a photograph, a symbol, and a two dimensional shape.

The processor under control of the computer readable program code may be further configured to receive a selection of one or more colors, color schemes, textures, coatings, surface appearances, or other characteristics of the object.

The processor under control of the computer readable program code may be further configured to incorporate the selected one or more colors, color schemes, textures, coatings, surface appearances, or other characteristics into the paper based 3D printer computer aided design model of the object.

The processor under control of the computer readable program code may be further configured to use a selected template of the object to produce the paper based 3D printer computer aided design model of the object.

### BRIEF DESCRIPTION OF THE DRAWINGS

The foregoing aspects and other features of the embodiments are explained in the following description, taken in connection with the accompanying drawings, wherein:

FIG. 1 shows a block diagram of an exemplary system 100 for producing an object according to the disclosed embodiments.

FIG. 2 shows a block diagram of an exemplary process for producing an object according to the exemplary embodiments;

FIG. 3 shows an exemplary process for creating a shape for use in producing a premade template according to the disclosed embodiments.

FIG. 4 shows an exemplary process for using the shape produced by the process in FIG. 3 to create a premade template according to the disclosed embodiments.

FIG. 5 shows some of the processes of FIG. 2 in greater detail.

FIG. 6 shows an exemplary user supplied image.

FIG. 7 shows an example of a premade template for a jewelry piece.

FIG. 8 shows an example of a premade template for a plaque.

FIG. 9 shows an example of a premade template for a figure or doll.

FIG. 10 shows an example of an adjusted, edited user image.

FIG. 11 shows an exemplary 3D shape to be used for a premade template for a jewelry piece.

FIG. 12 shows an exemplary 3D shape to be used for a premade template for a plaque.

FIG. 13 shows an exemplary 3D shape to be used for a premade template for a figure or doll.

FIG. 14 shows the exemplary 3D shape to be used for a premade template for a jewelry piece as converted into a solid mesh.

FIG. 15 shows the exemplary 3D shape to be used for a premade template for a plaque as converted into a solid mesh.

FIG. 16 shows the exemplary 3D shape to be used for a premade template for a figure or doll as converted into a solid mesh.

FIG. 17 shows the solid mesh of the jewelry premade template after smoothing.

FIG. 18 shows the result of one or more Boolean operations used to create one or more mounting holes.

FIG. 19 shows an exemplary pattern to be used in generating a premade tem plate.

FIG. 20 shows an example of a 3D shape with UV texture to be used in generating a premade template for a jewelry piece.

FIG. 21 shows the result of merging an edited user supplied image with a UV texture of a user selected premade template for a jewelry piece.

FIG. 22 shows different views of an example of a finished object.

FIG. 23 shows an example where the object is a finished jewelry piece with one or more added jewelry findings.

### DETAILED DESCRIPTION

The disclosed embodiments are directed to designing and fabricating objects from paper feedstock.

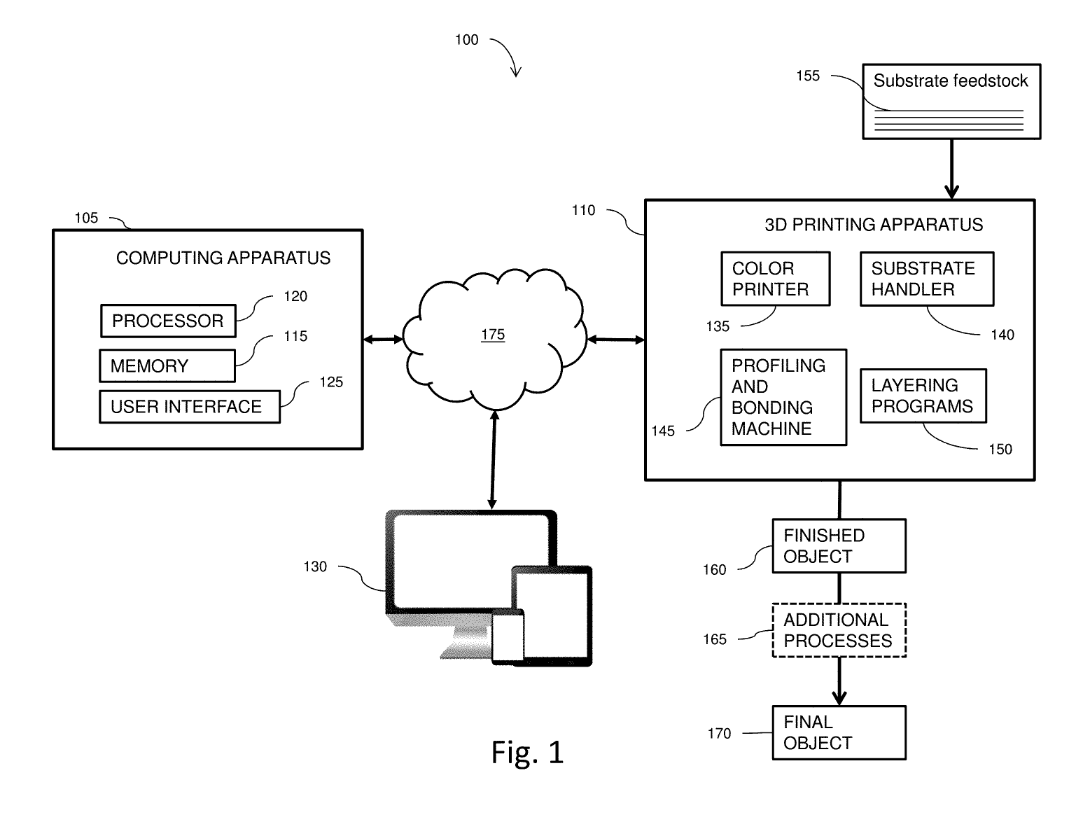

FIG. 1 shows a block diagram of an exemplary system 100 for producing objects according to the disclosed embodiments. The system may include a computing apparatus 105 that may communicate with user devices 130 and a printing apparatus 110. The computing apparatus 105, devices 130 and printing apparatus 110 may be connected by a network 175, for example, a local area network or a wide area network, and in one or more embodiments, may remotely located from each other.

The computing apparatus 105 may include computer readable program code stored on at least one computer readable medium 115 for carrying out and executing the process steps described herein. In particular, the computing apparatus 105 may include computer readable program code for carrying out and executing the exemplary processes for producing a jewelry item described herein. The computer readable medium 115 may be a memory of the computing apparatus 105. In alternate aspects, the computer readable program code may be stored in a memory external to, or remote from, the computing apparatus 105. The memory may include magnetic media, semiconductor media, optical media, or any media which is readable and executable by a computer. Computing apparatus 105 may also include a microprocessor 120 for executing the computer readable program code stored on the at least one computer readable medium 115. In at least one aspect, computing apparatus may include a user interface 125 which may operate to allow communication between the computing apparatus 105 and one or more user devices 130. A non-limiting example of the computing device may include one or more servers at specific geographical locations or a distributed cloud service. A non-limiting example of the one or more user devices 130 may include a personal computer, tablet, mobile phone, or any suitable device for communicating with computing apparatus 105. In at least one embodiment, the one or more user devices 130 may provide a user with the ability to provide an image to the computing apparatus 105 for processing as described herein.

The printing apparatus 110 may be a 3D printing apparatus for printing on various substrates, such as paper, and may include a color printer 135, a substrate handler 140, a profiling and bonding machine 145, and layering programs 150 for controlling layering or stacking of a number of substrates 155. While the color printer 135, substrate handler 140, profiling and bonding machine 145 are shown as separate mechanisms, it should be understood that two or more of the mechanisms may be integrated together in any combination. While the 3D printing apparatus may be described in the context of a layered paper 3D printer, it should be understood that any suitable substrate may be used to produce the embodiments as disclosed.

The substrate handler 140 may be operable to introduce one or more substrates 155 into the 3D printing apparatus 110 and transport one or more substrates 155 through the printing apparatus 110. The color printer 135 may be configured to apply ink to one or both sides of the substrate 155. The substrate handler 140 may operate to transport the printed substrate to the profiling and bonding machine 145 which may operate to cut each printed substrate to a profile and bond the cut substrate to a previously cut substrate layer. When all substrate layers have been colored, profiled and bonded, the resulting object may be weeded, that is, separated from excess pieces of the substrate layers to yield a finished object 160. In some embodiments, one or more additional processes 165, for example, a coating process may optionally be applied to the finished object 160 to provide a particular texture, appearance, or characteristic. For example, one or more of a waterproof, glossy, transparent, translucent, or opaque coating may be applied to the finished object to yield a final object 170.

One or more embodiments may include using the 3D printing apparatus 110 to produce other finished objects and assembling a number of finished objects together as an assembly as part of the additional processes 165. For example, a number of objects may be produced from the same set of substrate layers, weeded, and then fastened together to yield a final object. A number of objects may also be produced and weeded separately and then fastened together to yield a final object. For example, where the final object is a plaque, components of the plaque such as a base and mountings may be produced as separate objects and the fastened together to form the final plaque.

In some embodiments, a finished object may be modified, for example, by machining, drilling, or otherwise modifying a physical attribute of the finished object as part of the additional processes, such as adding mounting holes, adjusting dimensions for proper fit, or other operations.

Where the finished object 160 is a piece of jewelry, jewelry findings, for example, clasps, loops, rings, bracelets, bangles, brooch pins, cuff link mountings, or any other suitable objects may be added to the finished object 160 as part of the additional processes 165 to produce the final object 170.

While the disclosed embodiments are described in the context of producing a finished jewelry piece, it should be understood that the structures and techniques described herein may be used to produce an item of wearable art, a charm, bangle, bauble, keychain, pendant, or other jewelry item, a plaque, trophy, doll, figure, or any suitable 3D object. Furthermore, while the disclosed embodiments include various techniques for producing shapes, premade templates, adjusted, edited user images, and other techniques for processing a user supplied image to yield a CAD file for a 3D printer, it should be understood that the various techniques described are exemplary and that other techniques may be used to produce the same or similar results.

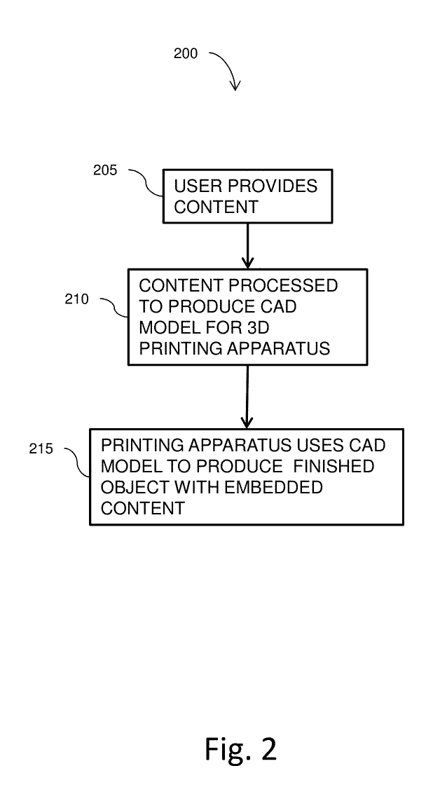

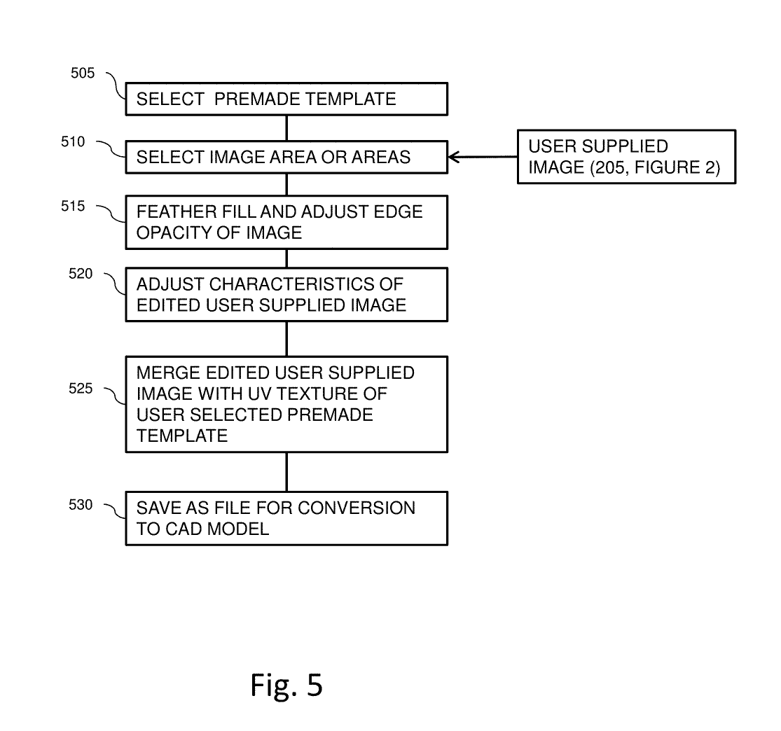

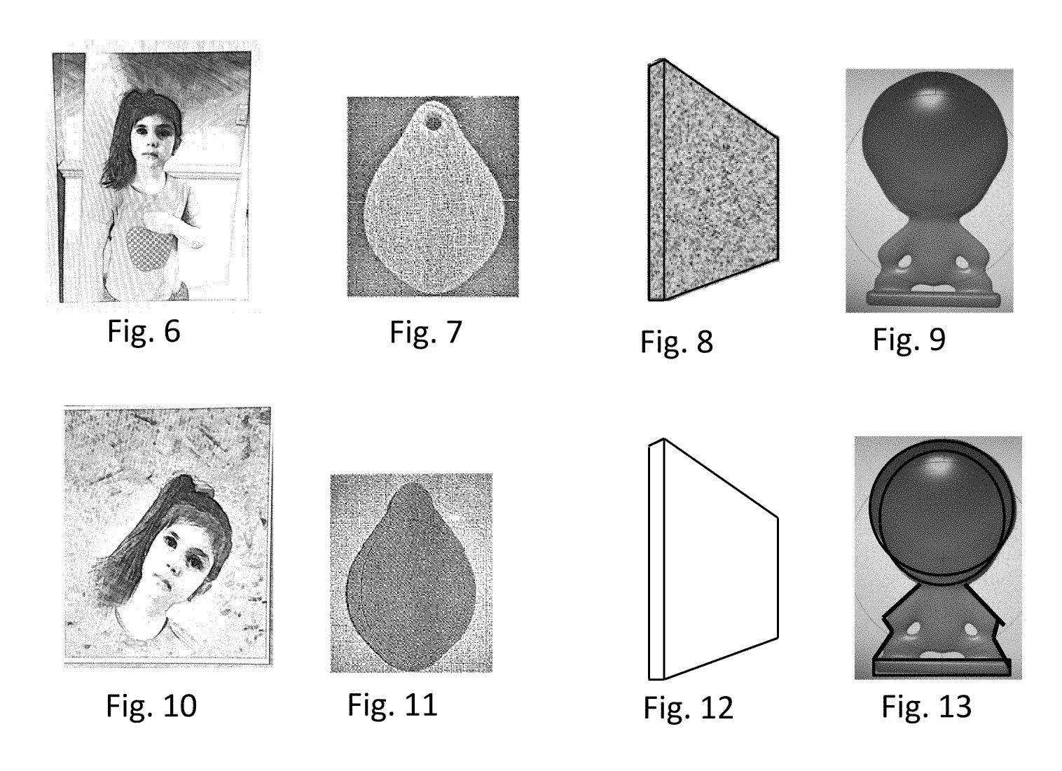

FIG. 2 shows a block diagram of an exemplary process for producing an object according to the exemplary embodiments. As shown in block 205, a user provides an image, for example using one or more user devices 130. The user supplied image may be provided in hardcopy or electronic format and may be artwork, a photograph, a design, a logo, a document, an image or model of an object, or any other image. In some embodiments, the image provided may be a two dimensional (2D) or 3D image. FIG. 6 shows an exemplary user supplied image.

As shown in block 210, the image may be processed to yield a computer aided design (CAD) model of an object for the 3D printing apparatus 110. As part of the image processing, the user may designate or describe a piece or template of an object to which the image is to be applied. In some embodiments, the user may select a premade template from a menu of templates as the designated template. In one or more embodiments, the user may select a premade template from the menu and may customize the selected template by specifying different dimensions or additional features to be incorporated into the premade template to arrive at the designated template. FIG. 7 shows an example of a premade template for a jewelry piece, FIG. 8 shows an example of a premade template for a plaque, and FIG. 9 shows an example of a premade template for a figure or doll.

The image processing may further include adjusting one or more of a brightness, contrast, vibrancy, hue, saturation, size, and orientation of the user supplied image and selecting an area on the designated template for application of the adjusted user image. The adjusted user image may then be applied to the selected area, and may be further edited to conform to characteristics of the designated template. For example, edges of the adjusted user image may be feathered and the opacity of the edges of the edges may be adjusted. In addition, missing portions or data may be added to the image, image data may be distorted, and image content may be adjusted or edited. In one or more embodiments, the adjustments and edits described herein may be performed by an artisan performing the image processing. FIG. 10 shows an example of an adjusted, edited user image.

The image processing may still further include providing the user with the ability to select one or more colors, color schemes, textures, coatings, surface appearances, or other characteristics of the finished object. The user may select the one or more characteristics from a predetermined menu of finished object characteristics or may specify one or more custom characteristics. For example, a user may select a texture, color or shape so that the finished object may appear to be made of wood, metal or stone.

The resulting computer aided design (CAD) model of a jewelry piece for the 3D printing apparatus 110 may be any suitable 3D printer model, including one or more of an STL, OBJ, VRML, or COLLADA model.

As shown in block 215, the printing apparatus 110 uses the resulting CAD model to produce a finished jewelry item with the image embedded in the piece.

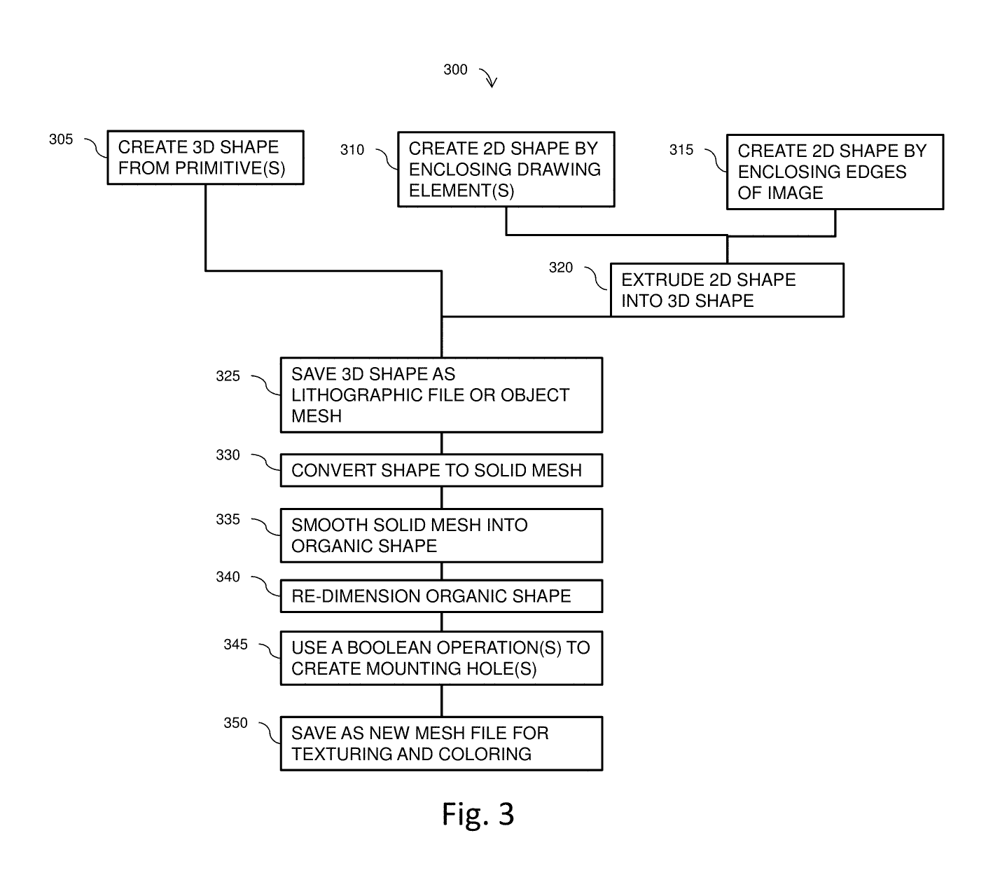

FIG. 3 shows an exemplary process 300 for creating a shape for use in producing a premade template according to the disclosed embodiments.

As shown in block 305, the process may begin by initially creating a 3D shape from a primitive or a Boolean operation on two or more primitives. For purposes of the disclosed embodiments, a primitive may include a cube, cylinder, sphere, cone, pyramid, or torus.

In the alternative, as shown in block 310, the process of producing a premade template may begin by creating a 2D shape by enclosing one or more digital drawing elements. For purposes of the disclosed embodiments, a drawing element may include a point, vector, angle, line, plane, circle, square, triangle, arc, or spline.

As another alternative, as shown in block 315, the process may begin by creating a 2D shape by enclosing edges of an image or part of an image.

As shown in block 320, the 2D shape may be extruded into a 3 D shape.

The 3D shape may be saved as a lithographic file or object mesh as shown in block 325. An exemplary 3D shape for a jewelry piece premade template is shown in FIG. 11, an exemplary 3D shape for a plaque premade template is shown in FIG. 12, and an exemplary 3D shape for a figure or doll premade template is shown in FIG. 13.

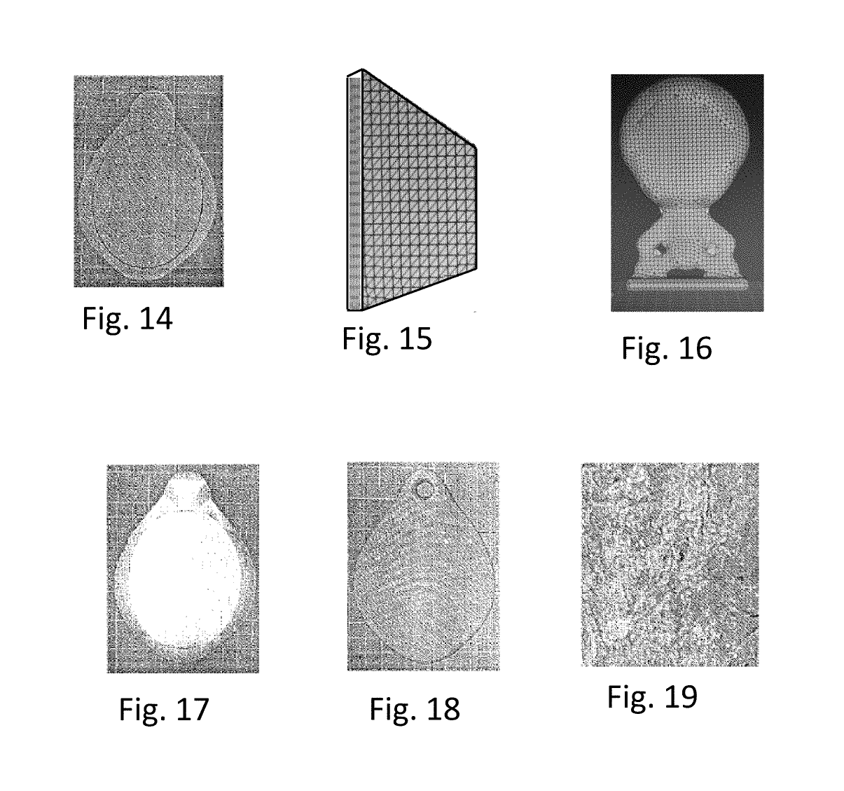

As shown in block 330 and in FIGS. 14-16, the 3D shapes may each be converted into a solid mesh.

The solid meshes may be smoothed to make them appear organic as shown in block 335. FIG. 17 shows the results of the smoothing operation for the exemplary jewelry piece solid mesh. While FIGS. 17-23 illustrate the disclosed embodiments as implemented for producing jewelry pieces, it should be understood that the techniques described herein may be used to produce an item of wearable art, a charm, bangle, bauble, keychain, pendant, or other jewelry item, a plaque, trophy, doll, figure, or any suitable 3D object.

As shown in block 340, the organic shape may be re-dimensioned to a desired length, width and depth.

One or more Boolean operations may be used to create one or more mounting holes to be used for example, in attaching one or more objects together, as shown in block 345 and in FIG. 18.

As shown in block 350, the shape may be saved as a 3D object mesh file for a texture and coloring processes.

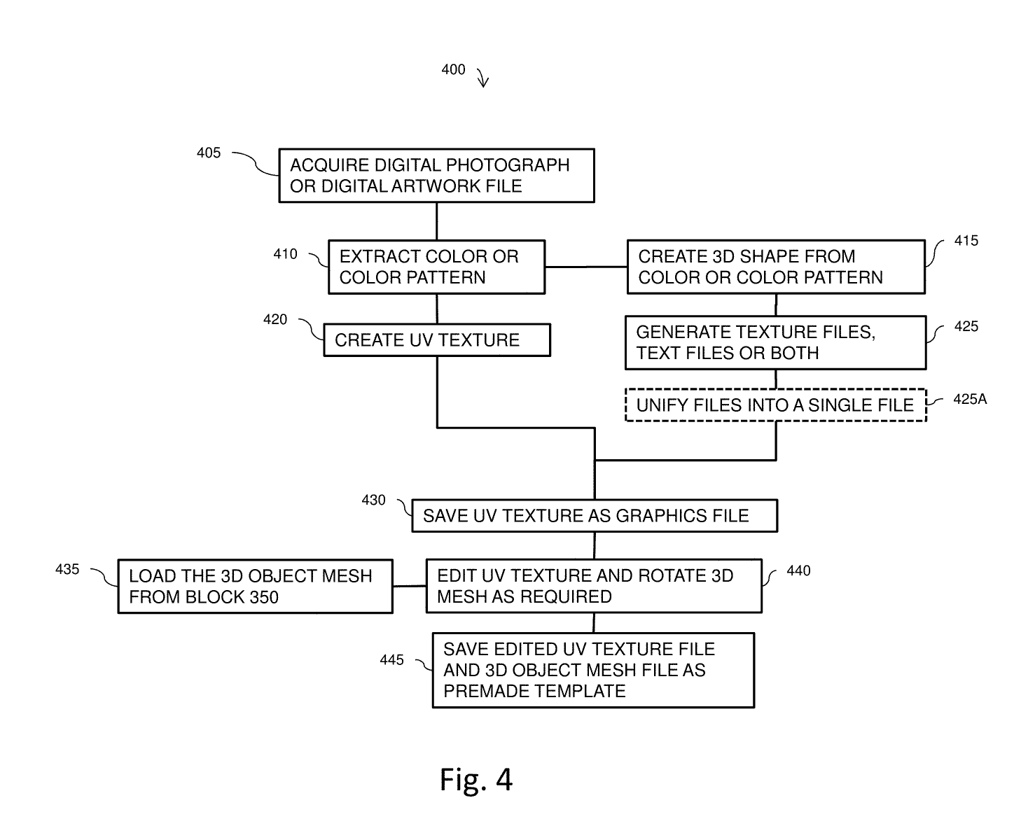

FIG. 4 shows an exemplary process 400 for using the shape produced by the process 300 to create a premade template according to the disclosed embodiments.

Block 405 includes acquiring a digital photograph or digital artwork file and in block 410, a color may be extracted or a color pattern may be created from at least a portion of the digital photograph. FIG. 19 shows an exemplary pattern.

In block 415, a 3D shape may be created from the color or pattern.

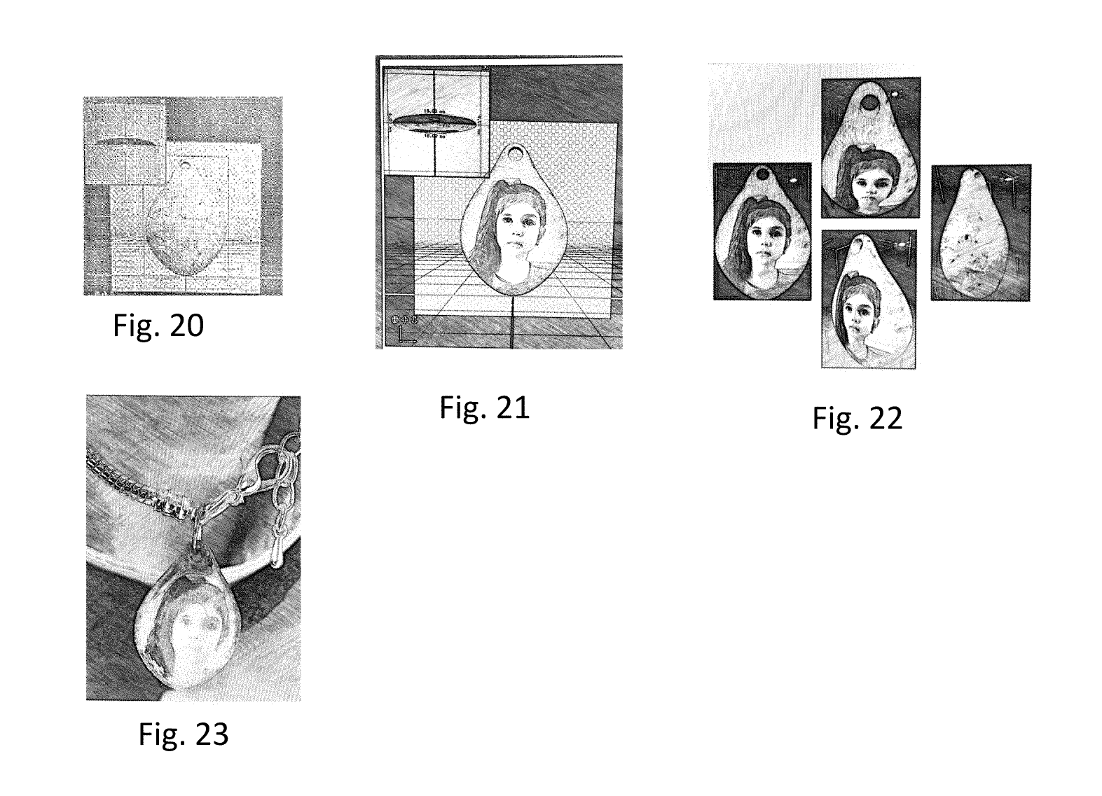

In block 420, a UV texture is created from the color or color pattern. An example of the 3D shape with UV texture is shown in FIG. 20.

In block 425, one or more texture files, text files, or both texture and text files may be generated. As shown in block 425A, the one or more texture and text files may optionally be unified into a single file

As shown in block 430, the UV texture is saved as any suitable graphics file, for example, a .png file.

As shown in block 435, the 3D object mesh file from block 350 may be retrieved and the UV texture from block 430 may be edited and the 3D mesh may be rotated as needed as shown in block 440.

The edited UV texture file and 3D object mesh file may be saved as a premade template, as shown in block 445.

FIG. 5 shows the processes of block 210 in FIG. 2 in greater detail. As shown in block 505, a user may select a premade template onto which the user supplied image 205 (FIG. 2) is to be applied.

An area of the premade template may be selected onto which the user supplied image is to be applied as shown in block 510, and the user supplied image may be edited by feather filling and adjusting an opacity of the image edge, as shown in block 515.

The size, placement, brightness, contrast, vibrancy, hue, saturation, and any other suitable characteristic of the edited user supplied image may be adjusted, for example, by an artisan, as shown in block 520.

As shown in block 525, the edited user supplied image may be merged with the UV texture of the user selected premade template. FIG. 21 shows an exemplary result of this process.

The user selected premade template and the merged UV texture may be saved as any suitable file structure or format for conversion to a CAD model for use by the printing apparatus, as shown in block 530.

As mentioned above, after the piece has been printed by the 3D printer, a coating may optionally be applied to the finished piece. Different views of an example of a finished piece are shown in FIG. 22. As also mentioned above, one or more jewelry findings may be added to the finished piece, as shown in FIG. 23. assembling the pieces together

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the disclosed embodiments.

1. A process for making an object having unique embedded user content from paper feedstock, comprising:
receiving content from a user;
processing the content to produce a paper based three dimensional (3D) printer computer aided design model of an object incorporating the content; and
using a paper based 3D printer to produce a finished object from paper feedstock using the computer aided design model, wherein the content is imprinted in the finished object.

2. The process of claim 1, wherein the content comprises an image of one or more of artwork, a design, a document, a drawing, an image, a letter, a logo, a number, a photograph, a symbol, and a two dimensional shape.

3. The process of claim 1, wherein processing the content includes selecting one or more colors, color schemes, textures, coatings, surface appearances, or other characteristics of the object.

4. The process of claim 3, comprising incorporating the selected one or more colors, color schemes, textures, coatings, surface appearances, or other characteristics into the paper based 3D printer computer aided design model of the object.

5. The process of claim 1, wherein processing the content includes using a selected template of the object to produce the paper based 3D printer computer aided design model of the object.

6. The process of claim 1, wherein the finished object is a jewelry piece and the process further comprises adding one or findings to the jewelry piece.

7. The process of claim 1, further comprising applying a coating to the finished object.

8. The process of claim 1, comprising:
using the paper based 3D printer to produce a plurality of finished objects from paper feedstock using the computer aided design model; and
assembling the plurality of finished objects together as a final object.

9. The process of claim 8, wherein the final object is a plaque.

10. An apparatus for making an object having unique embedded user content from paper feedstock, comprising:
a computing apparatus having a processor and a memory with computer readable program code, wherein the processor under control of the computer readable program code is configured to:
receive content from a user; and
process the content to produce a paper based three dimensional (3D) printer computer aided design model of an object incorporating the content;
the apparatus further comprising a paper based 3D printer configured to produce a finished object from paper feedstock using the computer aided design model, wherein the content is imprinted in the finished object.

11. The apparatus of claim 10, wherein the content comprises an image of one or more of artwork, a design, a document, a drawing, an image, a letter, a logo, a number, a photograph, a symbol, and a two dimensional shape.

12. The apparatus of claim 10, wherein the processor under control of the computer readable program code is further configured to receive a selection of one or more colors, color schemes, textures, coatings, surface appearances, or other characteristics of the object.

13. The apparatus of claim 12, wherein the processor under control of the computer readable program code is further configured to incorporate the selected one or more colors, color schemes, textures, coatings, surface appearances, or other characteristics into the paper based 3D printer computer aided design model of the object.

14. The apparatus of claim 10, wherein the processor under control of the computer readable program code is further configured to use a selected template of the object to produce the paper based 3D printer computer aided design model of the object.

15. The apparatus of claim 10, wherein the finished object is a jewelry piece.

16. The apparatus of claim 10, wherein the final object is a plaque.
